(19) United States
(12) Patent Application Publication
(10) Pub. No.: US 2001/0018944 A1
(43) Pub. Date: Sep. 6, 2001

(54) Chafer rubber composition, and heavy duty pneumatic tire using the chafer rubber composition

(76) Inventor: Yoichi Mizuno, Kobe-shi (JP)

Correspondence Address: BIRCH STEWART KOLASCH & BIRCH, PO BOX 747, FALLS CHURCH, VA, 22040-0747, US

(21) Appl. No.: 09/784,041

(22) Filed: Feb. 16, 2001

(30) Foreign Application Priority Data
Feb. 16, 2000 (JP) 2000-37932 PAT.

(51) Int. Cl. B60C 1/00

(52) U.S. Cl. 152/547

(57) ABSTRACT

The rubber composition for chafer is characterized in that 55-75 parts by weight of carbon black having a nitrogen adsorption specific surface area of 70-120 m²/g and 0.2-0.5 parts by weight of 1, 3-bis (citraconimidomethyl) benzene are blended with respect to 100 parts by weight of a rubber component including 30-50 parts by weight of natural rubber and/or polyisoprene rubber and 50-70 parts by weight of polybutadiene rubber. The pneumatic tire utilizing the chafer rubber composition is excellent in creep resistance, toe-cracking resistance, rim-slippage resistance of a bead portion through its lifetime from the beginning to the end of running, and durability of the bead portion. In the case of a tubeless tire, it also exhibits good air-tightness, thereby ensuring retention of the internal pressure.

### BACKGROUND OF THE INVENTION

1. Field of the Invention

The present invention relates to a rubber composition for chafer used in a bead portion of a pneumatic tire, in particular a heavy duty pneumatic tire, and a heavy duty pneumatic tire employing the rubber composition for chafer.

2. Description of the Background Art

In a bead portion of a tire directly engaging with a rim, a chafer is often provided to prevent exposure of a tire reinforcing element due to abrasion of the bead portion, to strengthen the engagement between the tire and the rim, and further, in the case of a tubeless tire, to maintain a constant internal air pressure. Referring to FIGURE 1, the chafer 3 is placed at the bead portion 1 to directly face the rim, from a bead toe portion T through a bead heel portion H to reach a region opposing an upper end 2a of the rim flange 2. Particularly for the chafer of a heavy duty pneumatic tire that undergoes repeated severe deformation and highly exothermic conditions under a high internal pressure and heavy load, the following characteristics are required.

(1) Rim-Slippage Resistance

A tire at running undergoes repeated deformation, which causes friction between the chafer and the rim sheet or rim flange. Especially, a pneumatic tire for heavy-duty vehicle is subjected to heavy load as well as a severe temperature increase, and therefore, resistance to abrasion is a critical issue.

(2) Creep Resistance

Under the high internal pressure and heavy load, the chafer receives a strong compressive stress from the rim flange and bead sheet, and tends to suffer creep strain. This leads to stress strain of a bead reinforcing element, thereby causing break of the bead portion. Therefore, a rubber composition resistant to creep is demanded.

(3) Toe-Cracking Resistance

When mounting/dismounting a heavy duty pneumatic tire, in particular a tubeless tire, to/from a rim, the chafer toe portion suffers local deformation, which may cause the toe portion to crack. Such toe cracking leads to considerable deterioration of tire durability, and, in the case of the tubeless tire, the internal pressure retaining performance is degraded. The rubber composition improved in the creep resistance as described above, however, normally is poor in toe-cracking resistance.

As one of the conventional chafer rubber compositions, a highly rigid rubber composition is disclosed in Japanese Patent Laying-Open No. 7-118444, in which a filler and sulfur are blended into polybutadiene rubber containing a syndiotactic crystal component. The technique disclosed therein, however, does not satisfy all the characteristics required for a chafer as described above. Further, in Japanese Patent Laying-Open No. 7-81335, a compound rubber chafer is disclosed, which is made of several kinds of rubber with different characteristics connected and unitized together. With this technique, however, the process of connecting and unitizing several kinds of rubber requires large workload and cost.

### SUMMARY OF THE INVENTION

An object of the present invention is to provide a pneumatic tire, in particular a heavy duty pneumatic tire, which satisfies desired resistance to creep and toe-cracking at the same time, has rim-slippage resistance of the bead portion improved through its lifetime from the beginning to the end of running, thereby ensuring improved durability of the bead portion, and further, in the case of a tubeless tire, exhibits good air-tightness to maintain the internal pressure.

According to an aspect of the present invention, the rubber composition for chafer is characterized in that 55-75 parts by weight of carbon black having a nitrogen adsorption specific surface area of 70-120 m²/g and 0.2-0.5 parts by weight of 1, 3-bis (citraconimidomethyl) benzene are blended with respect to 100 parts by weight of a rubber component containing 30-50 parts by weight of natural rubber and/or polyisoprene rubber and 50-70 parts by weight of polybutadiene rubber.

Sulfur and vulcanization accelerator are preferably blended into the rubber composition in a ratio S/A of from 0.25 to 0.5, wherein S is the blended amount of the sulfur and A is the blended amount of the vulcanization accelerator.

According to another aspect of the present invention, the heavy duty pneumatic tire is characterized in that it employs in its bead portion the chafer rubber composition described above.

The foregoing and other objects, features, aspects and advantages of the present invention will become more apparent from the following detailed description of the present invention when taken in conjunction with the accompanying drawing.

### BRIEF DESCRIPTION OF THE DRAWINGS

FIGURE 1 is a cross sectional view of a bead portion of a tire for heavy-duty vehicle that is mounted on a rim.

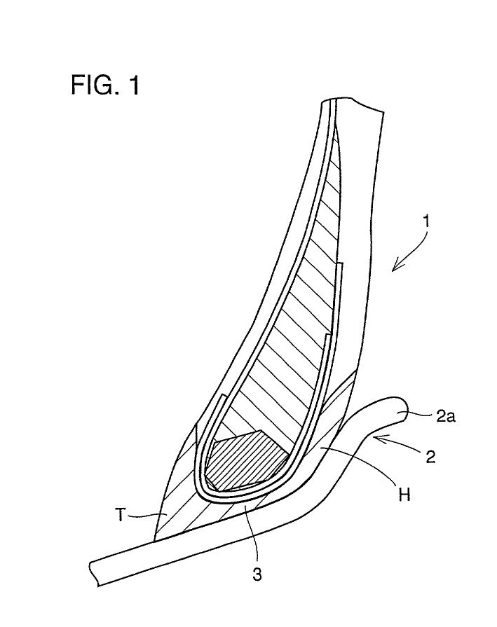

### DESCRIPTION OF THE PREFERRED EMBODIMENTS

The rubber component for use in the present invention includes 30-50 parts by weight of natural rubber and/or polyisoprene rubber and 50-70 parts by weight of polybutadiene rubber.

The chafer repeatedly undergoes severe deformation under a high internal pressure and heavy load, and its temperature tends to increase due to friction with the rim. Thus, it is necessary to maintain its toe-cracking resistance and rim-slippage resistance by restricting its heat generation as well as increasing its tensile strength and elongation. To this end, at least 30 parts by weight of natural rubber and/or polyisoprene rubber is included in the rubber component. If it exceeds 50 parts by weight, however, a sufficient level of hardness required for the chafer cannot be obtained.

As the polybutadiene rubber for use in the present invention, high cis-polybutadiene rubber whose cis content is at least 60% by weight, low cis-polybutadiene rubber whose cis content is less than 60% by weight, and vinyl polybutadiene rubber whose vinyl content is at least 20% by weight can be employed. In particular, polybutadiene rubber including at least 5% by weight of syndiotactic 1, 2 polybutadiene crystal (hereinafter, referred to as “syndiotactic crystal”) is preferable. If the weight of the polybutadiene rubber is less than 50 parts by weight, rubber hardness becomes poor, so that the rim-slippage resistance is degraded. On the other hand, if it exceeds 70 parts by weight, adhesion to the inner-layer rubber of the bead portion becomes poor, and further, its roll processibility is degraded and its exothermic property is increased.

The polybutadiene rubber has a syndiotactic crystal content of at least 5% by weight, preferably at least 10% by weight. If it is less than 5% by weight, it becomes necessary to blend a large amount of carbon black and/or sulfur in the rubber composition; otherwise, sufficient hardness and rigidity as well as a high level of rim-slippage resistance cannot be expected. Examples of the polybutadiene rubber containing desirable syndiotactic crystal include VCR 303, VCR 412 and VCR 617 manufactured by Ube Industries, Ltd. In the rubber composition of the present invention, styrene-butadiene copolymer rubber, butyl rubber, ethylene-propylene rubber or the like may be blended as another rubber component, in a blended amount not greater than 10 parts by weight.

The carbon black for use in the present invention has a nitrogen adsorption specific surface area of 70 to 120 m²/g. If it is less than 70 m²/g, a reinforcing effect is insufficient, so that desired abrasion resistance as well as hardness and rigidity cannot be expected for the rubber composition. On the other hand, if it exceeds 120 m²/g, exothermic property of the rubber composition increases, so that the rim-slippage resistance is degraded. Here, the nitrogen adsorption specific surface area is measured by the BET method according to ASTMD 3037-81. The carbon black is blended 55-75 parts by weight with respect to 100 parts by weight of the rubber component. If it is less than 55 parts by weight, the reinforcing effect is insufficient, and the levels of hardness and rigidity remain low. If it exceeds 75 parts by weight, the exothermic property increases and elongation at break decreases, so that the toe-cracking resistance is degraded.

In the rubber composition of the present invention, 1, 3-bis (citraconimidomethyl) benzene is blended 0.2-0.5 parts by weight with respect to 100 parts by weight of the rubber component. By blending the 1,3-bis (citraconimidomethyl) benzene, reversion not only at vulcanization in a mold but also due to heat generation at the running of the tire can be restricted. When the vulcanized rubber undergoes thermal hysteresis, the polysulfide bonds are broken, bonding and crosslinking take place again, so that the vulcanized rubber becomes harder. This considerably degrades the strength of the rubber. Here, the 1, 3-bis (citraconimidomethyl) benzene helps, by virtue of Diels-Alder reaction, formation of crosslinks after the break of sulfur bonds. The crosslinks thus obtained maintain flexibility of the same level as in the sulfur bonds and exhibit heat resistance of a higher level.

If the blended amount of the 1, 3-bis (citraconimidomethyl) benzene is less than 0.2 parts by weight, the effects as described above cannot be expected. If it exceeds 0.5 parts by weight, the effects enter a saturated state, which is economically disadvantageous.

In the present invention, the ratio S/A of the blended amounts of sulfur S and vulcanization accelerator A is preferably in a range between 0.25 and 0.5.

In general, the vulcanized rubber of sulfur vulcanized type that is formed of sulfur and vulcanization accelerator is poor in thermostability as it is formed primarily of the polysulfide crosslinks. Thus, in the present invention, the blended amount of sulfur is preferably made smaller compared to the blended amount of vulcanization accelerator so as to limit the number of sulfur per unit crosslinking, thereby restricting the formation of the polysulfide crosslinks. If the ratio S/A of the blended amounts thereof is less than 0.25, the crosslinking density becomes too small, and therefore, a required strength cannot be obtained. If it exceeds 0.5, however, the thermostability tends to be degraded. The blended amount of sulfur is preferably 0.3-2.0 parts by weight with respect to 100 parts by weight of the rubber component. If it is less than 0.3 parts by weight, the crosslinking density becomes too small. If it exceeds 2.0 parts by weight, the vulcanized rubber becomes too hard. The vulcanization accelerator for use in the present invention may be any of commonly used vulcanization accelerators, such as mercaptobenzothiazole, dibenzothiazyldisulfide, N-cyclohexylbenzothiazylsulfenamide, and N-tert-butyl-2-benzothiazolylsulfenamide. The blended amount of vulcanization accelerator is normally 0.3-5.0 parts by weight with respect to 100 parts by weight of rubber component, although it varies dependent on the blended amount of sulfur.

In the rubber composition of the present invention, ingredients commonly used for a tire rubber composition, e.g., silica, silane coupling agent, oil and wax, are blended as necessary.

### EXAMPLES

Ingredients as shown in Table 1 except for sulfur and vulcanization accelerator were blended and kneaded in a Banbury mixer at about 150° C. for five minutes. The sulfur and vulcanization accelerator were added to the obtained rubber composition, and it was further kneaded in a biaxial open roll at about 80° C. for five minutes.

The rubber composition thus obtained was used to mold a chafer divided into six portions in a circumferential direction of the tire. It was then vulcanized under the condition of 196N at 150° C. for 30 minutes. A truck tire of a size of 11R22.5 was thus manufactured.

Specifications of various kinds of carbon black employed in the ingredients are shown in Table 2.

TABLE 1

| Ingredients | | parts by weight |
|---|---|---|
| Rubber component | | 100 |
| Carbon black | | variable |
| 1,3-bis(citraconimidomethyl)benzene | ※2) | variable |
| Sulfur | ※3) | variable |
| Vulcanization accelerator | ※4) | variable |
| Process oil | ※5) | 4 |
| Antioxidant | ※6) | 3 |
| Wax | ※7) | 2 |
| Stearic acid | ※8) | 1 |
| Zinc oxide (Zinc white) | ※9) | 5 |

TABLE 2

| | | | Nitrogen |
|---|---|---|---|
| | | | Adsorption |
| | | | Specific |
| | | | Surface |
| | Manufacturer | Trade name | Area (m²/g) |
| Carbon black N220 | Mitsubishi Chemical | Diablack I | 114 |
| | Corporation | (N220) | |
| Carbon black N330 | Tokai Carbon | Seast N (N330) | 74 |
| | Co., Ltd. | | |
| Carbon black N110 | Tokai Carbon | Seast 9 (N110) | 142 |
| | Co., Ltd. | | |
| Carbon black N550 | Showa Cabot K. K. | Sho Black | 42 |
| | | (N550) | |

TABLE 3

| | Examples | | | | | | | | | | |
|---|---|---|---|---|---|---|---|---|---|---|---|
| (PHR) | 1 | 2 | 3 | 4 | 5 | 6 | 7 | 8 | 9 | 10 | 11 |
| Ingredients | | | | | | | | | | | |
| NR(natural rubber) | 40 | 40 | 30 | 40 | 40 | 40 | 40 | 40 | 40 | 40 | 40 |
| BR(polybutadiene rubber) ※1) | 60 | 60 | 70 | 60 | 60 | 60 | 60 | 60 | 60 | 60 | 60 |
| Carbon black N220 | 65 | 65 | 65 | | 55 | 75 | 65 | 65 | 65 | 65 | 65 |
| Carbon black N330 | | | | 65 | | | | | | | |
| Carbon black N110 | | | | | | | | | | | |
| Carbon black N550 | | | | | | | | | | | |
| 1,3-bis(citraconimidomethyl) | 0.2 | 0.5 | 0.2 | 0.2 | 0.2 | 0.2 | 0.2 | 0.2 | 0.2 | 0.2 | 0.2 |
| benzene ※2) | | | | | | | | | | | |
| Sulfur ※3) | 1 | 1 | 1 | 1 | 1 | 1 | 1 | 1 | 1 | 1 | 1 |
| Vulcanization accelerator ※4) | 2.5 | 2.5 | 2.5 | 2.5 | 2.5 | 2.5 | 1.5 | 2 | 3 | 4 | 4.5 |
| Performance | | | | | | | | | | | |
| (1) Loss tangent | 0.133 | 0.132 | 0.139 | 0.126 | 0.122 | 0.140 | 0.143 | 0.140 | 0.127 | 0.115 | 0.111 |
| (2) Hardness (JIS-A) | 78 | 78 | 78 | 78 | 76 | 81 | 75 | 77 | 79 | 80 | 81 |
| (3) Tensile properties | | | | | | | | | | | |
| Strength at break TB(MPa) | 20 | 21 | 19 | 17 | 19 | 23 | 21 | 21 | 20 | 19 | 17 |
| (O) before aging | | | | | | | | | | | |
| (A) after aging | 18 | 18 | 17 | 16 | 17 | 19 | 16 | 17 | 18 | 18 | 16 |
| Retention (A/0) | 90 | 86 | 89 | 94 | 89 | 83 | 76 | 81 | 90 | 95 | 94 |
| Elongation at break EB (%) | 220 | 224 | 216 | 200 | 241 | 201 | 240 | 230 | 214 | 210 | 197 |
| (O) before aging | | | | | | | | | | | |
| (A) after aging | 165 | 169 | 167 | 160 | 200 | 152 | 168 | 165 | 160 | 160 | 155 |
| Retention (A/O) | 75 | 75 | 77 | 80 | 83 | 76 | 70 | 72 | 74 | 76 | 79 |
| (4) Appearance of tire | | | | | | | | | | | |
| after road test | | | | | | | | | | | |
| Chafing | no | no | no | no | no | no | no | no | no | no | no |
| Crack | no | no | no | no | no | no | no | no | no | no | no |

TABLE 4

| | Comparative examples | | | | | | | |
|---|---|---|---|---|---|---|---|---|
| (PHR) | 1 | 2 | 3 | 4 | 5 | 6 | 7 | 8 |
| Ingredients | | | | | | | | |
| NR (natural rubber) | 40 | 40 | 40 | 20 | 40 | 40 | 40 | 40 |
| BR (polybutadiene rubber) ※1) | 60 | 60 | 60 | 80 | 60 | 60 | 60 | 60 |
| Carbon black N220 | 65 | 65 | 65 | 65 | | | 45 | 85 |
| Carbon black N330 | | | | | | | | |
| Carbon black N110 | | | | | 65 | | | |
| Carbon black N550 | | | | | | 65 | | |
| 1,3-bis(citraconimidomethyl)benzene ※2) | | 0.1 | 0.7 | 0.2 | 0.2 | 0.2 | 0.2 | 0.2 |
| Sulfur ※3) | 1 | 1 | 1 | 1 | 1 | 1 | 1 | 1 |
| Vulcanization accelerator ※4) | 2.5 | 2.5 | 2.5 | 2.5 | 2.5 | 2.5 | 2.5 | 2.5 |
| Performance | | | | | | | | |
| (1) Loss tangent | 0.135 | 0.136 | 0.130 | 0.145 | 0.148 | 0.112 | 0.109 | 0.167 |
| (2) Hardness | 78 | 78 | 78 | 79 | 81 | 75 | 71 | 85 |
| (3) Tensile properties | | | | | | | | |
| Strength at break TB(MPa) | | | | | | | | |
| (O) before aging | 21 | 21 | 20 | 18 | 23 | 15 | 15 | 25 |
| (A) after aging | 15 | 15 | 18 | 15 | 19 | 13 | 14 | 18 |
| Retention (A/O) | 71 | 71 | 90 | 83 | 83 | 87 | 93 | 72 |
| Elongation at break EB (%) | | | | | | | | |
| (O) before aging | 215 | 220 | 225 | 210 | 240 | 190 | 260 | 145 |
| (A) after aging | 150 | 155 | 168 | 156 | 180 | 160 | 230 | 102 |
| Retention (A/O) | 70 | 70 | 75 | 74 | 75 | 84 | 88 | 70 |
| (4) Appearance of tire after road test | | | | | | | | |
| Chafing | no | no | no | no | no | yes | yes | no |
| Crack | no | no | no | no | no | no | no | yes |

Details of the ingredients shown in Tables 1, 3 and 4 are as follows:

[symbol] 1) Polybutadiene: VCR 412 (from Ube Industries, Ltd.), syndiotactic crystal content: 12% by weight

[symbol] 2) 1, 3-bis (citraconimidomethyl) benzene: Perkalink 900 (from Flexsys)

[symbol] 3) Sulfur: Sulfur (from Tsurumi Chemical Industry Co., Ltd.)

[symbol] 4) Vulcanization accelerator: Nocceler NS (N-tert-butyl-2-benzothiazolylsulfenamide) (from Ouchishinko Chemical Industrial Co., Ltd.)

[symbol] 5) Process oil: Diana Process AH40 (from Idemitsu Kosan Co., Ltd.)

[symbol] 6) Antioxidant: Ozonon 6C (from Seiko Chemical Co., Ltd.)

[symbol] 7) Wax: Sannoc Wax (from Ouchishinko Chemical Industrial Co., Ltd.)

[symbol] 8) Stearic acid: Kiri (from NOF Corporation)

[symbol] 9) Zinc oxide: Ginrei R (from Toho Zinc Co., Ltd.)

Performance evaluation methods for the chafer rubber composition of the present invention and the tire using the chafer rubber composition are as follows.

(1) Loss Tangent (Viscoelasticity Test)

A test sample was obtained from a chafer rubber composition of a new tire. The loss tangent (tanδ) at 60° C. was measured using a viscoelasticity spectrometer manufactured by Iwamoto Co., Ltd., under the conditions of dynamic strain of 1.0% and at a frequency of 10 Hz. The smaller value shows a lower tanδ, which corresponds to lower exothermic property, and hence, better performance and better rolling resistance.

(2) Hardness (JIS-A)

The hardness of new tire tread rubber was measured at 25° C. using a JIS-A hardness tester.

(3) Tensile Test

A test sample was obtained from the chafer rubber composition of a new tire, for which the tensile test was conducted using a #3 dumbbell according to JIS-K 6251 to measure strength at break TB and elongation at break EB. (O) show the properties of the test sample before being subjected to an aging process, and (A) show the properties of the test sample after it has undergone the aging process in an oven at 80° C. for 100 hours. The retention is represented as (A)/(O)×100(%). The larger value indicates a better result with a smaller property change observed.

(4) Road Test

The tire provided with the divided chafer was mounted on a 10-t truck. The appearance of the tire after running of 200 thousand kilometers was examined. Visual check was made to determine presence/absence of chafing and crack.

The evaluation results for Examples are shown in Table 3, and those for Comparative examples are shown in Table 4.

Evaluation Results

Comparative examples 1-3 and Examples 1 and 2 show that addition of 1, 3-bis (citraconimidomethyl) benzene helps improve tensile properties after aging. The performance improves when it is blended in an amount of 0.2-0.5 parts by weight, while further improvement is not observed if the blended amount exceeds 0.5 parts by weight.

Comparative example 4 and Examples 1 and 3 show that the tensile properties are degraded when the blended amount of polybutadiene rubber exceeds 70 parts by weight, as the loss tangent (tanδ) increases and the exothermic property deteriorates.

Comparative examples 5 and 6 and Examples 1 and 4 show that the exothermic property deteriorates when carbon black N110 having a large nitrogen adsorption specific surface area is utilized. They also show that chafing occurs when utilizing carbon black N550 whose nitrogen adsorption specific surface area is small, due to the insufficient rigidity.

Comparative examples 7 and 8 and Examples 1, 5 and 6 show that the blended amount of carbon black in the range of 55-75 parts by weight is desirable. If it is less than 55 parts by weight, the rigidity becomes small, thereby causing chafing to occur. If it exceeds 75 parts by weight, the exothermic property increases, so that crack appears.

Examples 1 and 7-11 show that, for the vulcanized rubber compositions, the ratio of sulfur to vulcanization accelerator blended therein is preferably less than 0.5, and, from the standpoint of the initial physical properties, it is preferably larger than 0.25.

As explained above, the rubber composition for chafer according to the present invention includes specific rubber components, and a prescribed amount of 1, 3-bis (citraconimidomethyl) benzene is blended into the carbon black blended type composition. Accordingly, it is possible to improve the fundamental characteristics of a chafer, i.e., rim-slippage resistance, creep resistance and toe-cracking resistance, totally in a well-balanced manner.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A rubber composition for chafer, characterized in that 55-75 parts by weight of carbon black having a nitrogen adsorption specific surface area of 70-120 m²/g and 0.2-0.5 parts by weight of 1, 3-bis (citraconimidomethyl) benzene are blended with respect to 100 parts by weight of a rubber component including 30-50 parts by weight of natural rubber and/or polyisoprene rubber and 50-70 parts by weight of polybutadiene rubber.

2. The chafer rubber composition according to claim 1, wherein a ratio S/A of a blended amount of sulfur S and a blended amount of vulcanization accelerator A is in a range between 0.25 and 0.5.

3. A heavy duty pneumatic tire, characterized in that it employs in its bead portion the chafer rubber composition according to claim 1.
